(19) United States
(12) Patent Application Publication
(10) Pub. No.: US 2013/0274946 A1
(43) Pub. Date: Oct. 17, 2013

(54) METHODS AND SYSTEMS FOR CONTROLLING A POWER PLANT

(71) Applicants: Owen Jannis Schelenz, Schenectady, NY (US); Kathleen Ann O'Brien, Niskayuna, NY (US); David Smith, Daleville, VA (US); Xinhui Wu, Schenectady, NY (US)

(72) Inventors: Owen Jannis Schelenz, Schenectady, NY (US); Kathleen Ann O'Brien, Niskayuna, NY (US); David Smith, Daleville, VA (US); Xinhui Wu, Schenectady, NY (US)

(21) Appl. No.: 13/446,423

(22) Filed: Apr. 13, 2012

(51) Int. Cl. G06F 1/26

(52) U.S. Cl. 700/297

(57) ABSTRACT

A power plant for providing alternating current (AC) power to an electrical grid is described. The power plant includes a first power converter couplable to the electrical grid at a first point of interconnection for receiving power from a first power source. The power plant also includes a second power converter couplable to the electrical grid at the first point of interconnection for receiving power from a second power source. The power plant also includes at least one sensor for measuring a voltage level at the first point of interconnection and a central controller for coordinating operation of the first power converter and the second power converter to determine an impedance of the electrical grid.

### BACKGROUND OF THE INVENTION

The embodiments described herein relate generally to control of a power plant that includes a plurality of power converters coupled to an electrical grid, and more specifically, to controlling the plurality of power converters to determine electrical grid parameters.

Solar energy has increasingly become an attractive source of energy and has been recognized as a clean, renewable alternative form of energy. Solar collector systems utilize a plurality of photovoltaic (PV) arrays to convert solar energy incident on the PV arrays into direct current (DC) power. Typically, the DC output of the PV arrays is coupled to a DC to alternating current (AC) inverter to convert the DC output of the PV arrays into a suitable AC waveform that can be fed to a power grid. Furthermore, the AC output of the DC to AC inverter may be provided to a transformer that increases the voltage of the AC power prior to applying the AC power to the electrical grid.

A solar farm typically includes a plurality of DC to AC inverters each coupled to, and configured to receive power from, a plurality of PV arrays. Output terminals of the DC to AC inverters are coupled to the electrical grid at a point of interconnection. More specifically, the output terminals are coupled to conductors and at least one transformer that deliver power to the point of interconnection. When a solar farm is commissioned, individual inverters may perform a self-configuration routine to determine inverter control parameters based on measured output terminal parameters. For example, an inverter controller may instruct an inverter to output various levels of reactive current and to monitor the voltage level at the output terminals for each level of reactive current output by the inverter. The inverter controller uses the changes in the voltage level to determine an impedance at the output terminals of the inverter. However, actions performed by the individual inverters may not be substantial enough when compared to a total size of the solar farm, and more specifically, to a minimum size of the grid connection, to accurately measure grid parameters, for example, an impedance of the electrical grid. Furthermore, actions performed by one inverter may interfere with actions performed by another inverter and prevent accurate measurement of grid parameters.

### BRIEF DESCRIPTION OF THE INVENTION

In one aspect, a power plant for providing alternating current (AC) power to an electrical grid is provided. The power plant includes a first power converter couplable to the electrical grid at a first point of interconnection for receiving power from a first power source, a second power converter couplable to the electrical grid at the first point of interconnection for receiving power from a second power source, and at least one sensor for measuring a voltage level at the first point of interconnection. The power plant also includes a central controller for coordinating operation of the first power converter and the second power converter to determine an impedance of the electrical grid.

In another aspect, a central controller communicatively coupled to a plurality of power converters and configured to control operation of the power converters is provided. Each of the power converters is configured to provide power to an electrical grid at a first point of interconnection. The controller includes an input configured to receive a voltage level signal corresponding to a voltage level at the first point of interconnection. The controller also includes an output configured to transmit an impedance test signal to the power converters, wherein the power converters are configured to operate in accordance with the impedance test signal. The controller also includes a processing device configured to determine the impedance of the electrical grid by varying a reactive power output of the power converters and monitoring a change in the voltage level at the first point of interconnection caused by the varied reactive power.

In yet another aspect, a method for controlling a plurality of power converters included within a power plant is provided. The power converters are configured to provide power to an electrical grid at a first point of interconnection. The method includes providing an impedance test signal to the power converters instructing each power converter to vary a reactive current output. The method also includes monitoring a voltage level at the first point of interconnection and determining an impedance of the electrical grid at the first point of interconnection based at least partially on a measured change in voltage level at the first point of interconnection in response to the varied reactive current.

### BRIEF DESCRIPTION OF THE DRAWINGS

FIG. 1 is a block diagram of an exemplary power plant that includes a plurality of power converters.

FIG. 2 is a flow chart of an exemplary method for controlling operation of the plurality of power converters included within the power plant shown in FIG. 1.

### DETAILED DESCRIPTION OF THE INVENTION

The methods and systems described herein facilitate determining grid parameters through coordinated control of a plurality of power converters included within the power plant. More specifically, a central controller is configured to coordinate operation of the power converters such that accurate determinations of grid parameters may be obtained. The methods and systems described herein may be applied during commissioning of a power plant and/or at predefined times during operation of the power plant.

Technical effects of the methods and systems described herein include at least one of: (a) providing an impedance test signal to a plurality of power converters instructing each power converter to vary a reactive current output; (b) monitoring a voltage level at a first point of interconnection; and (c) determining an impedance of the electrical grid at the first point of interconnection based at least partially on a measured change in voltage level at the first point of interconnection in response to the varied reactive current.

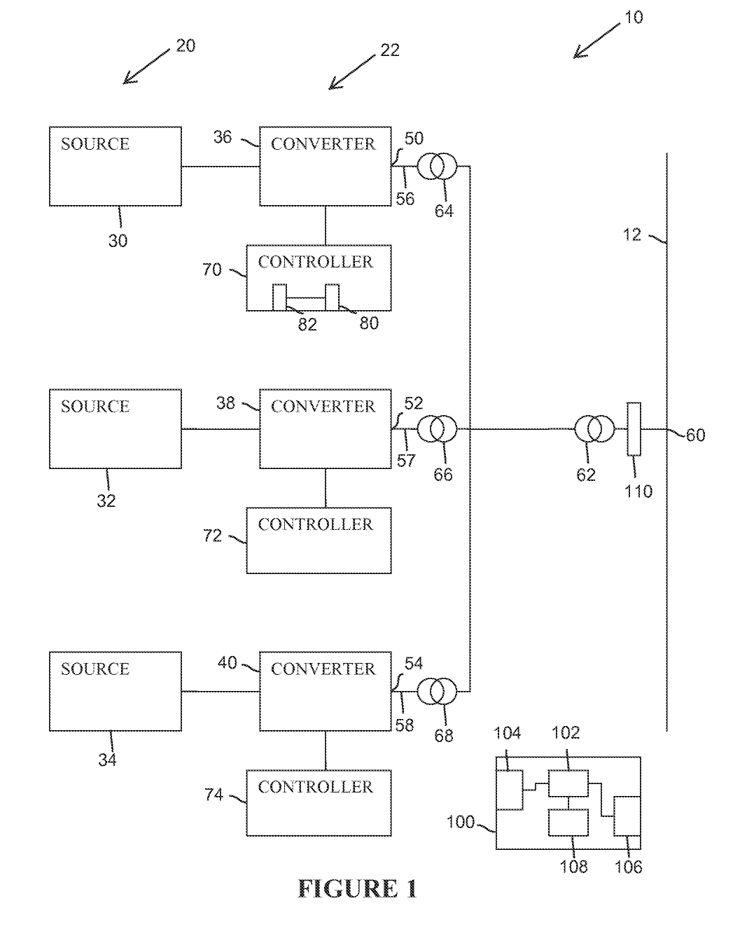

FIG. 1 is a block diagram of an exemplary power plant 10 configured to provide power to an electrical grid 12. In the exemplary embodiment, power plant 10 includes a plurality of power sources 20 and a plurality of power converters 22. For example, plurality of power sources 20 may include, but are not limited to, solar panels, wind turbines, energy storage devices (e.g., batteries and/or fuel cells), and/or any other type of power generation and/or storage system that includes a grid tied converter with reactive power capabilities.

In the illustrative embodiment, plurality of power sources 20 includes a first power source 30, a second power source 32, and a third power source 34. Furthermore, plurality of power converters 22 includes a first power converter 36, a second power converter 38, and a third power converter 40. Although described as including three power sources and three power converters, power plant 10 may include any number of power sources and power converters that allows power plant 10 to function as described herein.

First power source 30 is electrically coupled to, and configured to provide power to, first power converter 36. Second power source 32 is electrically coupled to, and configured to provide power to, second power converter 38. Third power source 34 is electrically coupled to, and configured to provide power to, third power converter 40. If desired, multiple power sources may be coupled to a single power converter in some embodiments. Furthermore, first power converter 36 includes at least one output terminal 50, second power converter 38 includes at least one output terminal 52, and third power converter 40 includes at least one output terminal 54. Output terminals 50, 52, and 54 are electrically coupled to a first point of interconnection 60 of electrical grid 12, for example, by a first conductor or plurality of conductors 56, a second conductor or plurality of conductors 57, and a third conductor or plurality of conductors 58, respectively. In an exemplary embodiment, power plant 10 also includes a grid transformer 62, coupled between converter output terminals 50, 52, and 54 and first point of interconnection 60.

As referred to herein, electrical grid 12 is a network of conductors and devices configured for distribution and/or transmission of electricity. Grid transformer 62 may include, but is not limited to including, a step-up transformer, an isolation transformer, and/or any other type of transformer within a distribution/transmission network. Grid transformer 62 receives power from power converters 36, 38, and 40, increases a voltage level of the power, and applies it to electrical grid 12. In an alternative embodiment, power plant 10 may include a plurality of transformers, for example, a first transformer 64, a second transformer 66, and a third transformer 68. For example, first transformer 64 may be positioned between converter output terminal 50 and first point of interconnection 60, second transformer 66 may be positioned between converter output terminal 52 and first point of interconnection 60, and third transformer 68 may be positioned between converter output terminal 54 and first point of interconnection 60. In the alternative embodiment, each of transformers 64, 66, and 68 increases a voltage output by converters 36, 38, and 40 for application to electrical grid 12. Furthermore, in another alternative embodiment, power plant 10 may include grid transformer 62 and transformers 64, 66, and 68. And moreover, it is contemplated that if an output voltage of converters 36, 38, and 40 is high enough, no transformers may be needed between converter output terminals 50, 52, and 54 and first point of interconnection 60.

In the illustrative embodiment, power sources 30, 32, and 34 are direct current (DC) power sources that output a DC voltage to power converters 36, 38, and 40. In these embodiments, power converters 36, 38, and 40 include a DC to alternating current (AC) voltage inverter configured to convert the DC voltage to an AC voltage, for example, a three-phase AC voltage, which is provided to electrical grid 12. Furthermore, in some embodiments power converters 36, 38, and 40 may include dual stage power conversion systems comprising a DC to DC converter coupled by a DC link to a DC to AC inverter (not shown), for example.

Alternatively, power sources 30, 32, and 34 may be AC power sources that output an AC voltage to power converters 36, 38, and 40. In these embodiments, power converters 36, 38, and 40 include an AC to AC converter, which converts the received AC power to an AC power having a frequency and voltage that is suitable for injection onto electrical grid 12. Furthermore, in some embodiments power converters 36, 38, and 40 may include dual stage power conversion systems comprising an AC to DC converter coupled by a DC link to a DC to AC inverter (not shown), for example.

In the illustrative embodiment, first power converter 36 includes, or is coupled to, a converter controller 70 configured to control operation of first power converter 36. Furthermore, second power converter 38 includes, or is coupled to, a converter controller 72. Moreover, third power converter 40 includes, or is coupled to, converter controller 74. Converter controllers 70, 72, and 74 control operation of converters 36, 38, and 40 based on received signals and stored control algorithms.

In the illustrative embodiment, converter controller 70 includes a processing device 80 and a memory 82. Converter controller 70 is configured to control operation of power converter 36. For example, converter controller 70 may generate a conversion device control signal and provide the conversion device control signal to power converter 36. Power converter 36 operates in accordance with the conversion device control signal. Similarly, converter controllers 72 and 74 include processing devices and memories.

In the illustrative embodiment, power plant 10 also includes a central controller 100. In the illustrative embodiment, central controller 100 includes a processing device 102 coupled to an input 104, an output 106, and a memory device 108. Input 104 and output 106 may include input and output terminals configured for coupling to devices external to central controller 100, wireless devices configured to wirelessly communicate signals, and/or any other device or connection that allows central controller 100 to function as described herein. Central controller 100 is communicatively coupled to, and provides centralized control of, power converters 22. In the illustrative embodiment, central controller 100 coordinates operation of power converters 22 to determine an impedance of electrical grid 12. Furthermore, central controller 100 coordinates operation of power converters 22 to determine interplant impedances. For example, central controller 100 may control operation of, or direct converter controller 70 to, operate in such a way that facilitates determining an impedance of conductors, transformers, and/or any other electrical components positioned between power converter 36 and first point of interconnection 60. More specifically, the impedance of conductors 56, first transformer 64, and/or grid transformer 62 may be determined. The impedance of conductors and/or devices positioned between two points within power plant 10 is referred to herein as an interplant impedance.

In the illustrative embodiment, the interplant impedances and the impedance of electrical grid 12 are determined during commissioning of power plant 10. The interplant impedances and the impedance of electrical grid 12 may also be determined during operation of power plant 10. Determining the grid impedance and/or the interplant impedances is referred to herein as an impedance meter function of power plant 10. The grid impedance and/or interplant impedances may be monitored to analyze how the impedances change over time.

Power converters 22 provide closed-loop control of reactive power output by power converters 22. More specifically, controller 70 monitors a reactive power output by power converter 36, controller 72 monitors a reactive power output by power converter 38, and controller 74 monitors a reactive power output by power converter 40. Converter controller 70 generates a conversion device control signal based at least partially on the reactive power output of power converter 36 and converter 36 operates in accordance with the conversion device control signal, which affects the output of power converter 36. Similarly, converter controller 72 generates a conversion device control signal based at least partially on the reactive power output of power converter 38 and converter 38 operates in accordance with the conversion device control signal, which affects the output of power converter 38. Moreover, converter controller 74 generates a conversion device control signal based at least partially on the reactive power output of power converter 40 and converter 40 operates in accordance with the conversion device control signal, which affects the output of power converter 40.

In the illustrative embodiment, power plant 10 also provides closed-loop control of reactive power provided to first point of interconnection 60. For example, in the illustrative embodiment, power plant 10 includes a sensor 110 communicatively coupled to central controller 100. Sensor 110, central controller 100, and converter controllers 70, 72, and 74 are coupled in a closed-loop configuration to provide closed-loop control of reactive power provided to first point of interconnection 60. Sensor 110 (e.g., a transducer) measures at least one of a voltage level and a current level at point of interconnection 60 and transmits a corresponding signal to at least one of converter controller 70, converter controller 72, converter controller 74, and central controller 100. In the illustrative embodiment, central controller 100 generates a reactive current control signal based at least partially on the signal from sensor 110 and transmits the reactive current control signal to at least one of converter controller 70, converter controller 72, and converter controller 74. Converter controllers 70, 72, and/or 74 generates a conversion device control signal based at least partially on the reactive current control signal and transmits the conversion device control signal to a corresponding power converter. The corresponding power converter 36 operates in accordance with the conversion device control signal, which affects the output of power converter 36 and the power applied at first point of interconnection 60.

In the illustrative embodiment, to determine the grid impedance, central controller 100 generates an impedance test signal and transmits the signal to power converters 22. Power converters 22 operate in accordance with the impedance test signal, which includes applying various levels of reactive current to point of interconnection 60. Sensor 110 measures the voltage level at point of interconnection 60 for each level of reactive current applied by power converters 22. Central controller 100 uses the changes in the voltage level to determine the impedance seen by power converters 36, 38, and 40 at point of interconnection 60. For example, if the grid impedance is relatively low (i.e., the grid is relatively strong), a predefined change in the reactive current applied to transformer 62 will cause the voltage level at point of interconnection 60 to change a first amount. If the grid impedance is relatively high (i.e., the grid is relatively weak), the predefined change in the reactive current applied to transformer 62 will cause the voltage level at point of interconnection 60 to change a second amount, wherein the second amount is greater than the first amount. In other words, central controller 100 can detect that the grid impedance is relatively high (i.e., the grid is relatively weak) when the predefined change in reactive current causes a relatively large change in the voltage level at point of interconnection 60.

In the illustrative embodiment, in response to the impedance test signal, each of power converters 36, 38, and 40 is configured to increase or decrease their reactive power output at substantially the same rate and by substantially the same amount. By coordinating the change in reactive power output by power plant 10, the collective effect of plurality of power converters 22 on the voltage level at point of interconnection 60 can be measured. Furthermore, a reactive power output capability of each individual power converter may be relatively small compared to the power level of electrical grid 12. For example, a ten megawatt power plant may include ten, one megawatt power converters coupled to an electrical grid at a minimum of a ten megawatt connection. Varying the reactive power output of one individual one megawatt power converter will not have a great effect on the voltage at the ten megawatt connection to the electrical grid. However, coordinating operation of all ten power converters, or a plurality of those ten power converters, increases the reactive power to a level that allows an accurate determination of grid impedance by measuring the change in the voltage at the ten megawatt connection to the electrical grid.

In the illustrative embodiment, central controller 100 is configured to increase or decrease the reactive power output of the plurality of power converters gradually over a first period of time. For example, the first period of time may be from 0.5 seconds to 5 seconds, or more specifically, from 1 second to 3 seconds. Gradually increasing or decreasing the reactive power output minimizes issues related to the length of time required to transmit a signal from central converter 100 to each of power converters 22. The times described herein are examples only. Times may be any length of time that allows power plant 10 to function as described herein.

In the illustrative embodiment, central controller 100 is configured to determine interplant impedances. For example, central controller 100 coordinates operation of power converters 22 to determine interplant impedances. More specifically, central controller 100 separately determines an impedance between first converter 36 and first point of interconnection 60, an impedance between second converter 38 and first point of interconnection 60, and an impedance between third converter 40 and first point of interconnection 60. Central controller 100 ensures that determining of one interplant impedance does not interfere with determining another inter plant impedance. For example, central controller 100 may control operation of, or direct converter controller 70 to, operate in such a way that facilitates determining an impedance of conductors, transformers, and/or any other electrical components positioned between power converter 36 and first point of interconnection 60. More specifically, the impedance of conductors 56, first transformer 64, and/or grid transformer 62 may be determined. For example, a voltage at output terminal 50 of power converter 36 may be compared to a time-correlated voltage at first point of interconnection 60 to determine the impedance of conductors and devices positioned between output terminal 50 and first point of interconnection 60. In other words, voltages measured at approximately the same time are compared to determine an interplant impedance between output terminal 50 and first point of interconnection 60.

Determining an interplant impedance of conductors and/or devices positioned between each power converter and first point of interconnection 60 allows central controller 100 to determine which power converter is best suited to provide efficient reactive power compensation when needed. For example, if central controller 100 determines reactive power output of power plant 10 should increase, central controller 100 may select the power converter with the lowest impedance between it and point of interconnection 60 to initially provide the additional reactive power. Central controller 100 may later determine that even more reactive power is required, and which time, central controller 100 requests that the other converters also provide additional reactive power.

Although illustrated as a separate controller, functions of central controller 100 may be performed by, for example, one of controllers 70, 72, and 74. For example, controller 70 may be configured to coordinate operation of power converters 22. More specifically, controller 70 may receive the signal from sensor 110 and be configured to generate a reactive current control signal and transmit the reactive current control signal to at least one of controllers 72 and 74.

In the illustrative embodiment, central controller 100 determines the impedance of electrical grid 12 and transmits a grid impedance signal corresponding to the determined impedance to converter controllers 70, 72, and 74. Converter controllers 70, 72, and 74 determine at least one control algorithm parameter value based at least partially on the grid impedance signal. For example, converter controllers 70, 72, and 74 may determine a gain that controls at least one of a magnitude of reactive power provided to electrical grid 12 and a rate of increase of reactive power provided to electrical grid 12. Converter controllers 70, 72, and 74 may also determine Voltage/VAR regulator gains, converter current regulator gains, current-impedance compensation for a phase locked loop, and/or any other control algorithm parameter value that allows power plant 10 to function as described herein.

For example, as described above, converter controller 70 includes memory device 82 that stores a conversion device control algorithm which generates the conversion device control signal. The conversion device control algorithm may include a parameter (e.g., a gain) that is dependent upon a strength of electrical grid 12 (i.e., an impedance of electrical grid 12). By changing this parameter, a response of power converter 36 to a measured change in voltage and/or current at point of interconnection 60 is dependent upon the strength of electrical grid 12. For example, a magnitude of a response to a measured change may be adjusted dependent upon the strength of electrical grid 12 so as to not exceed predetermined reactive power levels when the grid strength is low. More specifically, increasing the reactive power applied to electrical grid 12 when electrical grid 12 is weak causes a larger voltage change than if electrical grid 12 was strong. Therefore, when electrical grid 12 is weak, a gain within the conversion device control algorithm is set such that the algorithm outputs a softer addition of reactive power to electrical grid 12 so as to prevent a sudden change in the voltage at point of interconnection 60. When electrical grid 12 is strong, a stronger (i.e., more rapid) increase in reactive power may be provided to electrical grid 12 without causing a sudden change in the voltage at point of interconnection 60.

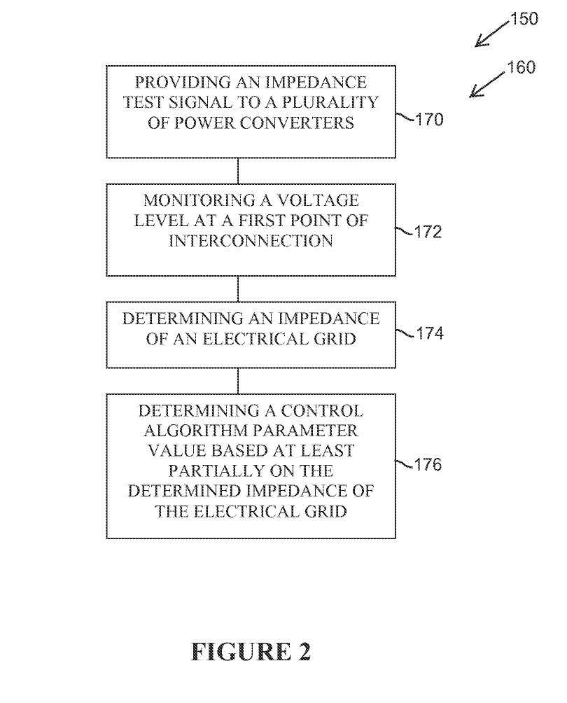

FIG. 2 is a flow chart 150 of an exemplary method 160 for controlling operation of a plurality of power converters included within a power plant, for example, power converters 22 (shown in FIG. 1) included within power plant 10 (shown in FIG. 1). As described above, power converters 22 are configured to provide power to an electrical grid, for example, electrical grid 12 (shown in FIG. 1) at a first point of interconnection, for example, first point of interconnection 60 (shown in FIG. 1). In the illustrative embodiment, method 160 includes providing 170 an impedance test signal to power converters 22 instructing each power converter to vary a reactive current output of the power converter. For example, central controller 100 provides 170 an impedance test signal to power converters 22 that instructs each power converter 22 to increase or decrease the reactive power output by substantially the same amount and at substantially the same rate. Furthermore, central controller 100 may instruct each power converter 22 to increase or decrease the reactive power output gradually over a first period of time.

Method 160 also includes monitoring 172 a voltage level at first point of interconnection 60 and determining 174 an impedance of electrical grid 12 at first point of interconnection 60 based at least partially on a measured change in voltage level at first point of interconnection 60 in response to the varied reactive current.

In the illustrative embodiment, method 160 may also include determining 176 a control algorithm parameter value used to control operation of at least one of plurality of power converters 22 based at least partially on the determined impedance of electrical grid 12. For example, a central controller, for example, central controller 100, may determine 176 a gain that controls at least one of a magnitude of reactive power and a rate of increase of reactive power provided to electrical grid 12 by at least one of the plurality of power converters 22.

In an alternative embodiment, method 160 includes transmitting a grid impedance signal corresponding to the determined impedance of electrical grid 12 to a first converter controller, for example, controller 70, associated with a first converter, for example, power converter 36, of plurality of converters 22. In the alternative embodiment, rather than central controller 100 determining the control algorithm parameter value, first converter controller 70 determines the control algorithm parameter value. The control algorithm parameter value used to control operation of first converter controller 70 based at least partially on the grid impedance signal.

Embodiments described herein embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

Described herein are exemplary methods and systems for determining grid parameters and/or interplant impedances during commissioning of a power plant and/or during operation of a power plant through coordinated control of a plurality of power converters included within the power plant. More specifically, a central controller is configured to coordinate operation of the plurality of power converters with the beneficial technical effect that accurate determinations of grid parameters and/or interplant impedances may be determined.

The methods and systems described herein facilitate efficient and economical control of a power plant. Exemplary embodiments of methods and systems are described and/or illustrated herein in detail. The methods and systems are not limited to the specific embodiments described herein, but rather, components of each system, as well as steps of each method, may be utilized independently and separately from other components and steps described herein. Each component, and each method step, can also be used in combination with other components and/or method steps.

Furthermore, unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean one, some, or all of the listed items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. Furthermore, the terms “circuit” and “circuitry” and “controller” may include either a single component or a plurality of components, which are either active and/or passive and are connected or otherwise coupled together to provide the described function.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A power plant for providing alternating current (AC) power to an electrical grid, said power plant comprising:
a first power converter couplable to the electrical grid at a first point of interconnection for receiving power from a first power source;
a second power converter couplable to the electrical grid at the first point of interconnection for receiving power from a second power source;
at least one sensor for measuring a voltage level at the first point of interconnection; and
a central controller for coordinating operation of said first power converter and said second power converter to determine an impedance of the electrical grid.

2. A power plant in accordance with claim 1, wherein said central controller is configured to generate an impedance test signal and to transmit the impedance test signal to said first and second power converters, wherein said first and second power converters are configured to operate in accordance with the impedance test signal.

3. A power plant in accordance with claim 2, wherein said central controller is configured to determine the impedance of the electrical grid by varying a reactive power output of said first and second power converters and monitoring a change in the voltage level at the first point of interconnection caused by the varied reactive power.

4. A power plant in accordance with claim 3, wherein said central controller is configured to increase or decrease the reactive power output of said first power converter at substantially the same rate and substantially the same amount as an increase or decrease in the reactive power output of said second power converter.

5. A power plant in accordance with claim 4, wherein said central controller is configured to increase or decrease the reactive power output of said first and second power converters gradually over a first period of time, wherein the first period of time is from approximately one second to approximately five seconds.

6. A power plant in accordance with claim 1, wherein said first power converter comprises a first converter controller and a memory, wherein said memory is coupled to, or included within, said first converter controller, said central controller is configured to transmit a grid impedance signal corresponding to the determined impedance of the electrical grid to said first converter controller.

7. A power plant in accordance with claim 6, wherein said memory is configured to store a converter control algorithm, and wherein said first converter controller is configured to determine a control algorithm parameter value based at least partially on the grid impedance signal.

8. A power plant in accordance with claim 7, wherein the converter control algorithm parameter comprises a gain that controls at least one of a magnitude of reactive power provided to the electrical grid and a rate of increase of reactive power provided to the electrical grid.

9. A central controller for controlling operation of a plurality of power converters configured to provide power to an electrical grid at a first point of interconnection, said controller comprising:
an input for receiving a voltage level signal corresponding to a voltage level at the first point of interconnection;
an output for transmitting an impedance test signal to said plurality of power converters; and
a processing device for determining the impedance of the electrical grid by varying a reactive power output of said plurality of power converters and monitoring a change in the voltage level at the first point of interconnection caused by the varied reactive power.

10. A central controller in accordance with claim 9, wherein said processing device is configured to increase or decrease the reactive power output of each of the plurality of power converters by substantially the same amount and at substantially the same rate.

11. A central controller in accordance with claim 10, wherein said central controller is configured to increase or decrease the reactive power output of said plurality of power converters gradually over a first period of time, wherein the first period of time is from approximately one second to approximately five seconds.

12. A central controller in accordance with claim 9, wherein said processing device is further configured to determine at least one control algorithm parameter value for use by the plurality of power converters based at least partially on the determined grid impedance.

13. A central controller in accordance with claim 12, wherein the at least one converter control algorithm parameter comprises a gain that controls at least one of a magnitude of reactive power provided to the electrical grid and a rate of increase of reactive power provided to the electrical grid.

14. A method for controlling a plurality of power converters included within a power plant, wherein the plurality of power converters are configured to provide power to an electrical grid at a first point of interconnection, said method comprising:
providing an impedance test signal to the plurality of power converters instructing each power converter to vary a reactive current output;
monitoring a voltage level at the first point of interconnection;
determining an impedance of the electrical grid at the first point of interconnection based at least partially on a measured change in voltage level at the first point of interconnection in response to the varied reactive current; and
controlling the plurality of power converters based at least in part on the determined impedance.

15. A method in accordance with claim 14, wherein controlling the plurality of power converters comprises determining a control algorithm parameter value used to control operation of at least one of the plurality of power converters based at least partially on the determined impedance of the electrical grid.

16. A method in accordance with claim 15, wherein determining a control algorithm parameter value comprises determining a gain that controls at least one of a magnitude of reactive power provided to the electrical grid by at least one of the plurality of power converters and a rate of increase of reactive power provided to the electrical grid by at least one of the plurality of power converters.

17. A method in accordance with claim 14, further comprising transmitting a grid impedance signal corresponding to the determined impedance of the electrical grid to a first converter controller associated with a first converter of the plurality of power converters.

18. A method in accordance with claim 17, wherein controlling the plurality of power converters comprises, determining, using the first converter controller, a control algorithm parameter value used to control operation of the first converter controller based at least partially on the grid impedance signal.

19. A method in accordance with claim 14, wherein providing an impedance test signal to the plurality of power converters comprises instructing each power converters to increase or decrease the reactive power output by substantially the same amount and at substantially the same rate.

20. A method in accordance with claim 14, further comprising:
receiving a voltage signal corresponding to a voltage at an output of a first power converter of the plurality of power converters; and
determining an interplant impedance between the first power converter and the first point of interconnection based at least partially on measurements, taken at approximately the same time, of the voltage at the output of the first converter and the voltage at the first point of interconnection.
